(19) United States
(12) Patent Application Publication
(10) Pub. No.: US 2014/0229363 A1
(43) Pub. Date: Aug. 14, 2014

(54) SYSTEM AND METHOD TO REQUEST AND COLLECT INFORMATION TO DETERMINE PERSONALIZED CREDIT

(71) Applicants: Sasha Peter Orloff, San Francisco, CA (US); Jacob Rosenberg, San Francisco, CA (US)

(72) Inventors: Sasha Peter Orloff, San Francisco, CA (US); Jacob Rosenberg, San Francisco, CA (US)

(21) Appl. No.: 13/766,317

(22) Filed: Feb. 13, 2013

(51) Int. Cl. G06Q 40/02

(52) U.S. Cl. CPC G06Q 40/025
USPC 705/38

(57) ABSTRACT

A method of providing a credit line or loan to a consumer is provided. A first user interface is presented to the consumer. First user behavior of the consumer while the consumer interacts with the first user interface is monitored. Then first user responses in response to the consumer interaction with the first user interface are received. A determination of a first set of information sources from which to retrieve information is made based on the first user responses. The information is then retrieved from the first set of information sources. Then the first user responses are evaluated as a function of the retrieved information from the first set of information sources and the monitored first user behavior. A decision as to the credit line or loan is made based on the evaluation.

### CROSS-REFERENCE TO RELATED APPLICATIONS

This application claims priority to the following U.S. Provisional applications: U.S. Provisional Application No. 61/598,203, filed on Feb. 13, 2012, and entitled, “SYSTEM AND METHOD TO REQUEST AND COLLECT INFORMATION TO DETERMINE PERSONALIZED CREDIT”; U.S. Provisional Application No. 61/598,213, filed on Feb. 13, 2012, and entitled, “SYSTEM AND METHOD FOR REAL TIME PRICING OF PERSONALIZED CREDIT”; U.S. Provisional Application No. 61/598,222, filed on Feb. 13, 2012, and entitled, “USER INTERFACE SYSTEM AND METHOD TO DYNAMICALLY DISPLAY RELATIONSHIP BETWEEN CREDIT AMOUNT, PAYBACK PERIOD AND PRICE”; and U.S. Provisional Application No. 61/598,231, filed on Feb. 13, 2012, and entitled, “USER INTERFACE SYSTEM AND METHOD USING IMAGE OF PHYSICAL INSTRUMENT TO DYNAMICALLY INPUT CREDIT INFORMATION,” all of which are hereby incorporated by reference in their entireties as if set forth herein.

### TECHNICAL FIELD

This document generally relates to systems and methods for use with retrieving information from multiple data sources for use in making credit determinations. More specifically, this document relates to methods and systems to request and collect information from multiple data sources to determine personalized credit.

### BACKGROUND

Consumers often can obtain credit (e.g., temporary authorizations for loans) from a number of different sources. For example, a consumer wishing to purchase a vehicle may visit with a finance department of an automobile dealership, which may then pull up a credit report for the consumer and make a decision as to whether or not to approve the requested amount. Other types of credit lenders may act with even less information than a credit report. For example, low value credit requests, such as ones for under $500, may make it not cost effective to pull a credit report, which costs money. For example, a payday lender may loan a small amount to a consumer with merely proof of identity and proof that a paycheck will be received in the next few weeks, without running a credit report.

In all instances, credit lenders could benefit from additional information about the creditworthiness of a consumer, yet currently there is no mechanism to make such information easily available. Information must be gathered manually, and the processes for gathering such information are generally the same for all applicants. The retrieval of such information is neither automated nor customized for the applicant at hand.

### BRIEF DESCRIPTION OF DRAWINGS

The present disclosure is illustrated by way of example and not limitation in the figures of the accompanying drawings, in which like references indicate similar elements and in which:

FIG. 1 is an illustrative concept level drawing of a system, in accordance with some example embodiments.

FIG. 2 is an illustrative drawing showing an architecture level view of the system and illustrating example changed configurations of the system in response to user responses, in accordance with some example embodiments.

FIG. 3 is an illustrative flow diagram of a process performed using the system of FIGS. 1-2, in accordance with some embodiments.

FIG. 4 is an illustrative diagram showing hypothetical sequences of User Interface (UI) displays presented to different users as a result of different responses by the different users to requests for information, in accordance with some embodiments of the system and method of FIGS. 1-3.

FIG. 5 is an illustrative drawing of a computer user interface display component for use in selecting a loan amount and loan term and for generating a corresponding repayment amount, in accordance with some embodiments.

FIG. 6 is an illustrative drawing of a computer user interface display for use in obtaining user information to use a user's bank account in connection with an Automated Clearing House (ACH) or wire transfer, in accordance with some embodiments.

FIG. 7 is an illustrative flow diagram 700 of a process to determine personalized real time credit, in accordance with some embodiments.

FIG. 8 is an illustrative drawing of a UI display that can be presented by the system 102 to a user device 104 to request user discount information for use in determining real time pricing of credit, in accordance with some embodiments.

FIG. 9 is an illustrative drawing representing a recursive process 900 to configure a computer system to obtain information to update a user model 901 encoded in a computer readable storage device 903 and to use the model to determine an offer of credit to a user in accordance with some embodiments.

FIGS. 10A-10B are illustrative drawings of modification of models 901A and 901B through multiple stages; the sending over a network of multiple UI display containing requests for attribute information; the sending of requests to collateral sources for attribute information; the corresponding receiving of responsive attribute information over the network; and the determination of a creditworthiness as a function of the attributes and associated attribute information of the models as modified pursuant to the process of FIG. 9.

FIG. 11 is a block diagram of a computer processing system at a server system, within which a set of instructions, for causing the computer to perform any one or more of the methodologies discussed herein, may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

In an example embodiment, a dynamic credit application system and method are provided to collect information to be used to evaluate creditworthiness of a credit applicant, and then actually evaluate credit worthiness. In real time, the user's/applicant's credit risk can be evaluated as a function of information provided by the user, user behavior with a UI, and information obtained from other information sources or internal databases (pre-obtained or retained). A determination is made as to whether additional information is necessary and, if so, what additional information to request from the user or other sources based upon the user provided information, user behavior, and information from other sources. In some embodiments, the UI display is implemented as one or more web pages, and a real time determination is made as to how many fields to display, require, and add/subtract, depending on the user's perceived creditworthiness/risk.

Information can be obtained over a computer network from a credit applicant using the aforementioned UI operating on a computer. As used herein, the term ‘computer’ as used encompasses a personal computer (PC), a tablet PC, a set-top box (STB), a personal digital assistant (PDA), cellular telephone, smart phone, or any processing device capable of executing a set of instructions (sequential or otherwise) that specify actions to be taken by that device. As used herein, the term ‘user interface’ refers to the graphical, textual, and auditory information for presentation to the user, and the control sequences (such as keystrokes with the computer keyboard, movements of the computer mouse, and selections with a touch screen) that a user employs to interact with an application. The term ‘user interface’ includes native mobile and desktop applications such as web UIs, voice or touch-tone phone menu systems, and Short Message Service (SMS) or Multimedia Messaging Service (MMS), provided that there is a secure enough communication channel. Web UIs accept input and provide output by generating web pages that are transmitted via the Internet and viewed by the user using a web browser program and that may include technologies to provide real-time control in a separate program (such as Java™, Asynchronous JavaScript and XML (AJAX), Adobe Flex™, and Microsoft .NET™, for example), thereby eliminating the need to refresh a traditional Hypertext Markup Language (HTML) based web browser. The term ‘user interface’ includes interfaces to mobile web applications such as mobile applications for use with mobile phone operating systems.

In some example embodiments, an online credit applicant/user fills out an application form with demographic, employment, and identity information. The system and method uses that data to pull additional information over a network from various data partners. A computer implemented dynamic decision system determines whether there is enough information to appropriately assess the applicant's credit risk. If not, additional information is requested from the applicant. Based on that new information, the system pulls additional information from the same or additional data partners to then appropriately assess credit risk. The system continues to request information from the applicant and additional information from data sources/partners and to evaluate the information until there is an appropriate assessment to approve or decline the credit decision for the applicant. This may continue in a back-and-forth manner until such an appropriate assessment can be made. At that point the system and method display a decision online to the applicant/user.

### EMBODIMENTS

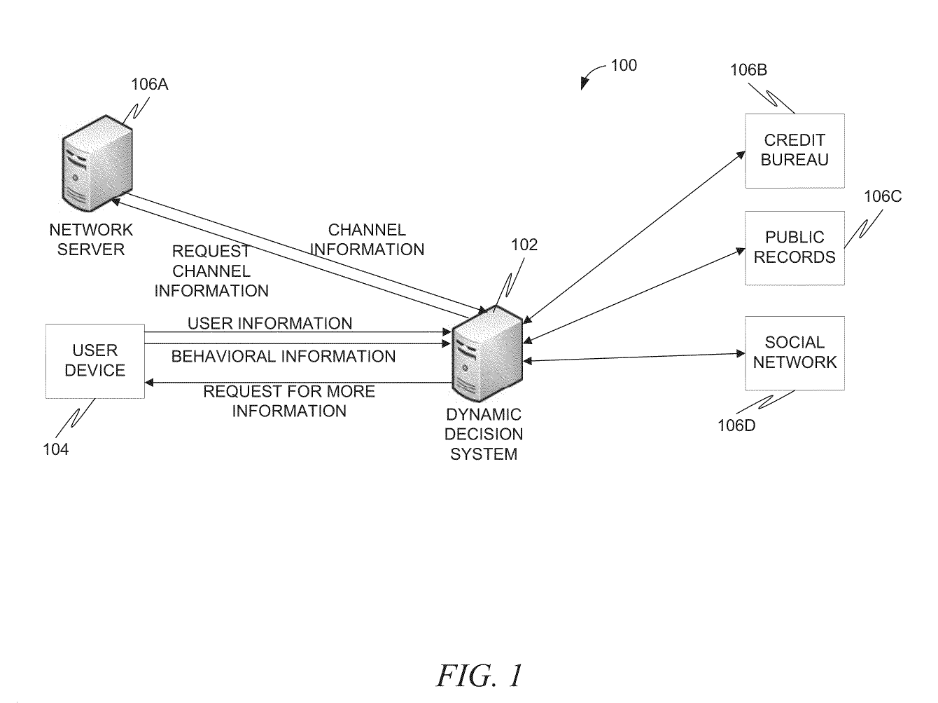

FIG. 1 is an illustrative concept level drawing of a system 100, in accordance with some example embodiments. A dynamic decision system 102 communicates with one or more user devices 104 (only one shown) and with multiple information sources A-106D using various network protocols such as Transmission Control Protocol/Internet Protocol (TCP/IP) or User Datagram Protocol (UDP) over a network such as the Internet and/or from databases or other data sources, for example. In some example embodiments, the dynamic decision system 102 is implemented using a server computer that engages in a client-server relationship with the user device 104. In some example embodiments, the information sources 106A-106D are implemented in server computer systems that engage in client-server relationship with the dynamic decision system 102. For example, information sources may include server computer systems operated by data service providers, thin file credit bureaus, social networks, census data sources, and financial services aggregators. In addition, the information sources also may include historical data previously retrieved from one or more of these sources or previously provided by the user, which is stored in a database associated with the dynamic decision system 102. Depicted here are four types of data sources, specifically a network server 106A, a credit bureau 106B, a public records database 106C, and a social network 106D. It should be noted that in many embodiments more than four types of data sources may be used, and there may be more than one instance of one or more of the types of data sources. For example, three social networks could be used as data sources.

In operation, for example, a user employs a user device 104 to communicate with the dynamic decision system 102 via the network. In some embodiments, in response to a user request sent via the device 104 to make an application for credit, the dynamic decision system 102 sends to the user device 104 one or more requests for information and receives responses to the requests from the user device 104. In the course of this exchange of requests for information and responses to the requests, the dynamic decision system 102 monitors user behavior. This monitored behavior itself can be used as a type of data source. Monitored user behavior may include measuring the time between response entries, changing of response entries, tracking movement between different response entry fields or web pages, the amount of typographical errors (even if corrected prior to completion of the entry), and so forth. Basically, any of the user interaction with the user device 104 when interfacing with the dynamic decision system 102 can be monitored and eventually (potentially) used in determining the creditworthiness of the user.

Additionally, channel information may be requested and retrieved from a network server 106A. Channel information may include information gathered about the user or the UI utilized by the user by the network server. This may include, for example, information gathered from collateral sources distinct from the user's own instant input, or information gathered from the user's own instant input itself. This information may include, for example, websites that referred the user device 104, search terms used with an Internet search engine, IP address, which browser is being used, which operating system is being used, the exact model or brand of the user device, the type of networking services used by the user device, geo-IP location, email address, phone number, and the global positioning system (GPS) location of the user device 104, for example. For example, a user in a higher-end neighborhood using an expensive mobile device with an expensive mobile carrier to submit the credit application may be a better credit risk than a user in a lower-end neighborhood using a cheap mobile device over a free public wi-fi network. The channel information may provide this level of detail that can be used in making the decision as to whether or not to extend credit (and if so, how much) to the user.

Also, in the course of the decision-making process, the dynamic decision system 102 gathers information from other information sources, here including a credit bureau 106B, public records database 106C, and a social network 106D. The information from these sources may be used together with the monitored user behavior to evaluate the user's credit worthiness, determine what additional requests to send to the user device 104, and to determine what other set of one or more of the information sources 106A-106D to contact to gather additional information to evaluate user responses to the additional requests. This process continues until arrival at a conclusive evaluation of the user's current credit worthiness.

For example, a user/credit applicant might enter into a user device 104 his or her name and Social Security Number (SSN) into the respective ‘name’ and ‘SSN’ fields of a UI display that acts to receive a credit application. The dynamic decision system 102 communicates over the network with multiple information sources, such as credit bureau 106B and public records database 106C, to determine whether the name and SSN pair corresponds to records on these sources. As another example, a user/credit applicant might enter into a user device 104 a physical address into a ‘home address’ field of a UI display. The dynamic decision system 102 communicates over the network with multiple information sources to determine whether the provided address is a valid address on a mapping system and/or whether the address is associated with any known historical fraud.

A determination based upon information obtained from one set of information sources that a user name plus SSN pair or a user home address is associated with historical problems paying back debt obligations could be a factor, for example, that militates against approval of credit. In some example embodiments, such a determination based upon user responses and information source responses indicating possibly poor creditworthiness, in turn, causes the decision making system 102 to send a further request for additional information to the user device 104, such as a request to identify third parties who might vouch for the user/applicant. A user response to such further request might identify social networking services in which the user participates. In some embodiments, the system 102 would send a request for information to such an identified social network 106D to determine the availability of a cosigner for a loan or the availability of a vouch system, for example, which could act as a countervailing factor in favor of the approval of credit. As such, the system 102 may send a request to the user device 104 requesting log-in information corresponding to the social network 106D.

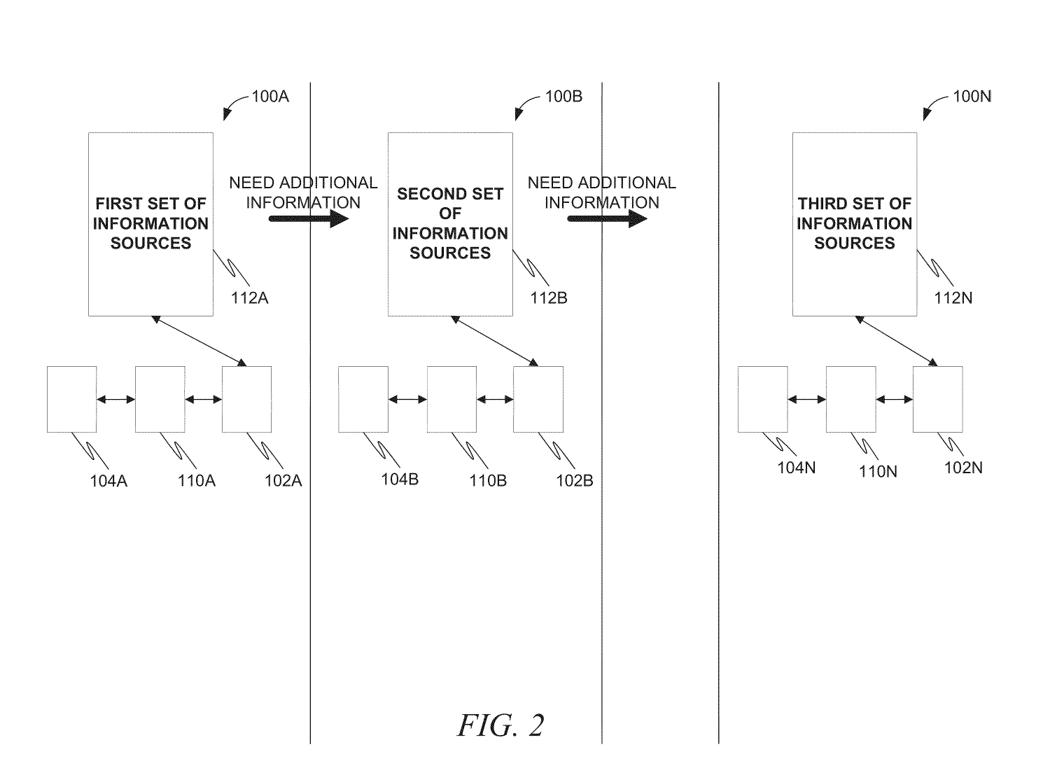

FIG. 2 is an illustrative drawing showing an architecture level view of the system 100 and illustrating example changed configurations of the system 100A-100N in response to user responses, in accordance with some example embodiments. It will be appreciated that the configuration of the system 100 transitions from a first configuration 100A to a second configuration 100B and through several other transitions (not shown) to an nth 100N configuration as the dynamic decision system 102 exchanges different requests/responses with the user device 104 and couples to different sets of information sources 106A-106D in response to different user responses to the different requests. It will be appreciated that there are not necessarily sharp demarcations between different configurations; rather, UI displays (e.g., web pages) and connections with information sources change in the course of the credit application process so that the configuration in effect evolves during the process. In FIGS. 1-2, identical reference numerals are used to indicate identical items (e.g., dynamic decision system) and items of the same kind (e.g., information sources), and letters associated with the reference numerals represent different configurations; the use of reference numerals without reference letters in FIGS. 1-2 indicates the items in general.

In some embodiments, the dynamic decision system 102 acts as a proxy for the information sources 106A-106D. User devices (only one shown, at 104) do not communicate directly with the information sources, but rather the dynamic decision system 102 makes decisions during a credit application process as to which data services to communicate with and when, and, where appropriate, to modify and update the application process/fields/experience based upon evaluation of user responses and user behavior in view of information provided by one or more sets of information sources. In some embodiments, the dynamic decision system 102 uses a customer facing web server to serve web pages and updates to the web pages to the user device 104. The web pages present requests for information and contain fields to receive user responses to the requests. The web pages provide information such as network addresses (e.g., web links) to address the user responses over the network to the dynamic decision system 102.

In operation, some embodiments, in a first configuration 200A, the user device 104A loads a user interface, such as an initial web page or a sequence of web pages, from the customer facing web server 110A and enters responses to requests on the page or sequence of pages to initiate an application for credit. The user device 104a sends the user responses to the web server 110A, which communicates the responses to the dynamic decision system 102a. Also, in some embodiments, while the user inputs information to the web page or set of web pages presented on the device 104A, the user's behavior is monitored. In some embodiments, for example, for a browser based UI, the dynamic decision system 102A collects information via JavaScript as a user interacts with elements of the web page displayed by the user device 104A and sends that information back to the decision system 102A for real-time analysis of observed user behavior. In other user interface displays, a different instrumentation method may be used to monitor user interaction and to send user behavior information to the system 102A. In addition, the system 102A can derive some user behavior information (such as speed of moving through an application) by simply observing the inputs of the user device 104.

In response to information in the user responses, the dynamic decision system 102A sends requests to a first set of information sources 112A, which comprises one or more of the information sources 106A-106D, to obtain additional information as a function of the user's first responses. In some embodiments, the dynamic decision system 102a evaluates the user responses, and the user behavior where appropriate, in order to determine the information sources to include in the first set 112A to which requests for information are sent. The dynamic decision system 102A evaluates the first responses as a function of the additional information obtained from the first set of information sources 112A, and where appropriate, as a function of the monitored user behavior. Based on the results of the evaluation, the dynamic decision system 102A sends to the user device a UI update that may involve sending a new or updated UI display (e.g., an updated web page) indicating credit approval, credit denial, or a request for additional information.

A determination by the dynamic decision system 102B to request additional information involves a transition to a second configuration of the system 200B. In the second configuration, the web server 110B serves one or more different web pages that include second, different, requests for information. Alternatively, in some embodiments, client code running on the user device 104B is responsible for running the workflow. although the dynamic decision system 102B is always the authority on determining what, if any, additional information to obtain for the user to finalize an application for credit. The dynamic decision system 102B receives the user's second responses to these second requests. The dynamic decision system 102B determines a second, same or different, set of information sources 112B as a function of the user's second responses. The dynamic decision system 102B evaluates the second responses as a function of the additional information obtained from the second set of information sources 112B, and where appropriate, as a function of the monitored user behavior. Based on the results of the evaluation, the dynamic decision system 102B sends to the user device a UI update that may involve sending a new or updated web page indicating credit approval, credit denial, or a request for additional information.

FIG. 2 illustrates that the process of requesting user information, receiving and evaluating responses (including behavior), and gathering information from different sets of information sources may continue through several different system configurations, until a credit acceptance or credit denial determination is made in some system configuration 200N, for example. Each different configuration involves delivery of different web pages/updates by the web server 110 and involves connections/communications between the dynamic decision system 102 and different sets of information sources 112A-112N. It will be appreciated that the system configurations 200A to 200N are determined dynamically as a function of user responses, user behavior, and information obtained from the information sources. Thus, the credit application process experienced by a user is configured dynamically for each different user based upon information provided by the user.

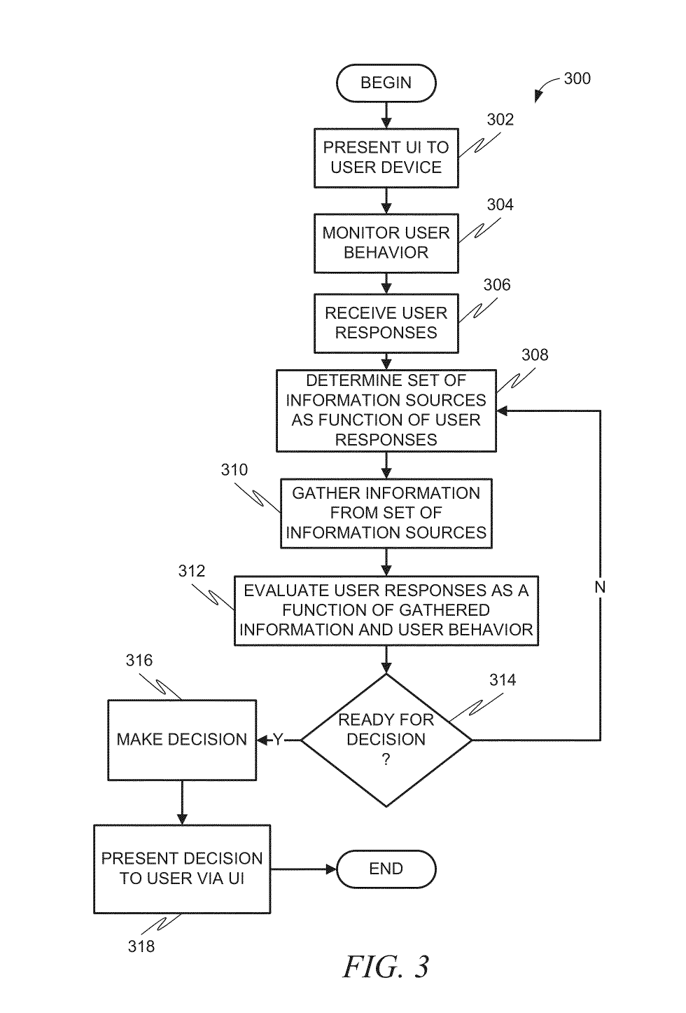

FIG. 3 is an illustrative flow diagram of a process 300 performed using the system of FIGS. 1-2, in accordance with some embodiments. The dynamic decision system 102 is configured using computer program code to implement the acts specified with reference to the modules of the flow diagram. At operation 302, a UI that includes requests for information is presented to the user device 104. In some embodiments, for example, the dynamic decision system 102 uses a web server to present a UI display that may include a sequence of web pages that are presented to gather information from the user. In some embodiments, the sequence of web pages may be determined dynamically based upon user input. More specifically, for example, the first user responses described above may be provided through a branching sequence of web pages.

At operation 304, user behavior in responding to the UI is monitored. At operation 306, user responses are received. At operation 308, the user responses are used to determine a set of information sources from which to request information. It should be noted that user responses may not be the sole determinant of which data sources to query. There may be other factors, including data cost, speed of response from data partners, quality and relevance of various data sources, particular revision of the decision model that is running, or even randomness, such as for experimental or testing purposes, as well as the monitored user behavior. At operation 310, information is gathered from the determined set of information sources. This may include sending requests to the individual sources of information and receiving information in response to the requests. At operation 312, the user responses are evaluated as a function of the information provided by the information sources of the determined set and user behavior. At operation 314, it is determined if the system can make a credit approval/denial decision based upon user responses and information received so far or if more information is required. If a credit approval decision can be made, then at operation 316, a decision is made, and at operation 318, the decision is presented to the user via the UI. If more information is required, then the process iterates to operation 308, where an additional set of information sources can be determined. As explained above, in some embodiments, the next UI display may include a branching sequence of web pages.

In some alternative embodiments, the credit decision may involve more than a yes/no approve/deny determination. Instead, the decision may involve a determination of how much credit and the terms on which credit will be offered, for example. In this alternative embodiment, operation 318 presents to the user a UI that indicates not only acceptance but also a credit amount. By way of background, some financial product entities just ask for a general credit but they never ask for a certain amount (such as a credit card, or a personal line of credit), and some applicants apply for credit for a very specific amount (such as a payday loan, where they want $250, or a particular store, where approval is sought for a new kitchen appliance costing $500, for example). In some alternative embodiments, a user applies and asks for an amount of money upfront (e.g., $100) and a determination is made whether the applicant is credit worthy and should be approved at all, and then as to the amount to lend. For example, operation 318 might indicate that a user is approved for up to $200 in credit depending upon one set of responses to requests for information, but might be approved for only for $50 based upon different responses.

It should be noted that the determination as to which sources to use may vary in real-time based on the cost of accessing these sources. Since these costs can change at any time, and may even vary based on the amount of traffic currently being handled by the sources, decisions can be made as to which information it is necessary to receive in real-time.

In some example embodiments, operation 318 presents to the user a UI that includes a price for a credit amount. In some embodiments, the operation 318 presents time as a variable. For example, system 102 might indicate that the user's loan will be funded immediately, or within 24 hours or 7 days, and, in addition, may indicate a variable decision as to the allowed length of time of time within which to repay the loan.

In some example embodiments, operation 318 indicates future discounts, which may vary based on risk (e.g., an offer of a high discount on a next loan to a user who is high-risk in order to encourage repayment).

In some example embodiments, operation 318 indicates a variation of an interest rate and/or cost of the loan based on risk, as discussed above with respect to the discounts.

In some example embodiments, operation 318 indicates which funding sources to allow a user to use to both fund and repay their loan. For example, a lower risk user may be allowed to receive money via an online cash card and to pay it back via a credit card, whereas a higher risk user may be allowed to use only his or her bank account via ACH to fund and repay the loan.

Thus, it will be appreciated that variables relating to the current loan (e.g., amount, cost, time to fund, time to pay back, funding and debit sources, etc.) and variables related to the lender's relationship with the user/applicant (e.g. discount level, ability to add new funding sources in the future, time between loans, etc.), may be influenced by this dynamic decision system 102.

Due to the variables involved, it is very possible not just that different users may receive different user interfaces and requests for different information, but even that the same user may receive different user interfaces and requests for different information on different days.

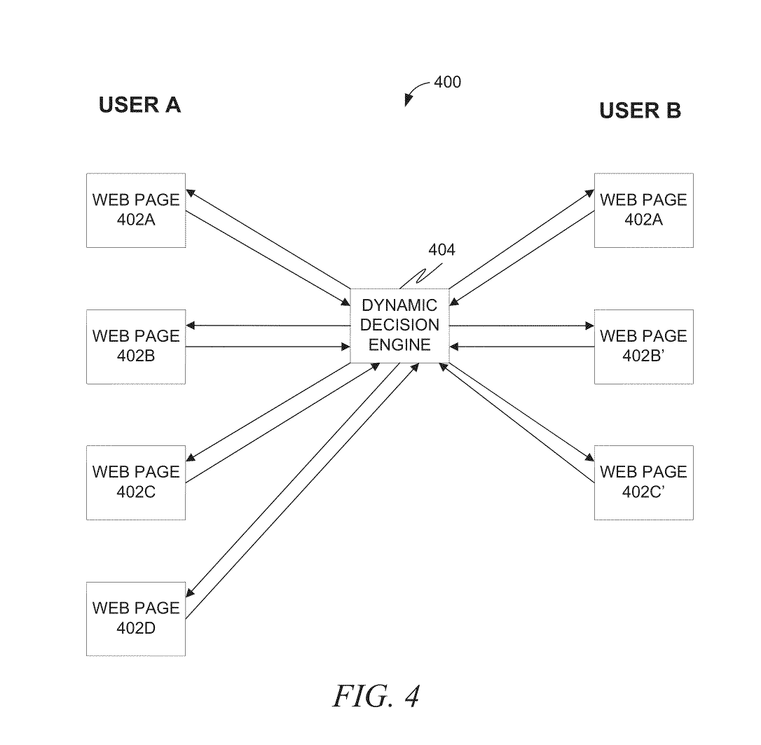

FIG. 4 is an illustrative diagram showing hypothetical sequences of UI displays 400 presented to different users as a result of different responses by the different users to requests for information, in accordance with some embodiments of the system and method of FIGS. 1-3. Assume, for example, that two different users (user A and user B) are using two different user devices (not shown) to apply for credit online using the system and method of FIGS. 1-3. Both users are initially presented the same or similar starting UI display, which here web is page 402A. Assume that in the course of the credit application process, user A responds to the fields in web page 402A, and the dynamic decision engine 404 uses this information to derive and present another web page, which here is web page 402B, which requests additional information, based on the previous responses, user behavior, and information from one or more information sources. User A then responds to web page 402B, and the dynamic decision engine 404 uses this information to derive and present another web page, which here is web page 402C, which requests additional information, based on the previous responses, user behavior, and information from one or more information sources. User A then responds to web page 402C, and the dynamic decision engine 404 uses this information to derive and present another web page, which here is web page 402D, which requests additional information, based on the previous responses, user behavior, and information from one or more information sources. User A then responds to web page 402D, and the dynamic decision engine 404 uses this information to determine that no additional information is needed to make the decision.

In contrast, while user B is presented with the same starting web page 402A, his or her responses to this web page result in a different web page, which in this case is web page 402B′, and the responses to this web page result in another different web page, which in this case is web page 402C′. At this point, the dynamic decision engine 404 determines that no additional information is needed to make the decision. Thus, both users have been presented with different web pages through the course of the interaction, and both users ultimately had a different number of web pages to complete before a decision could be made. This is due to the fact that each users' experience was personalized based on the information presented, monitored user behavior, and/or the information retrieved from the information sources.

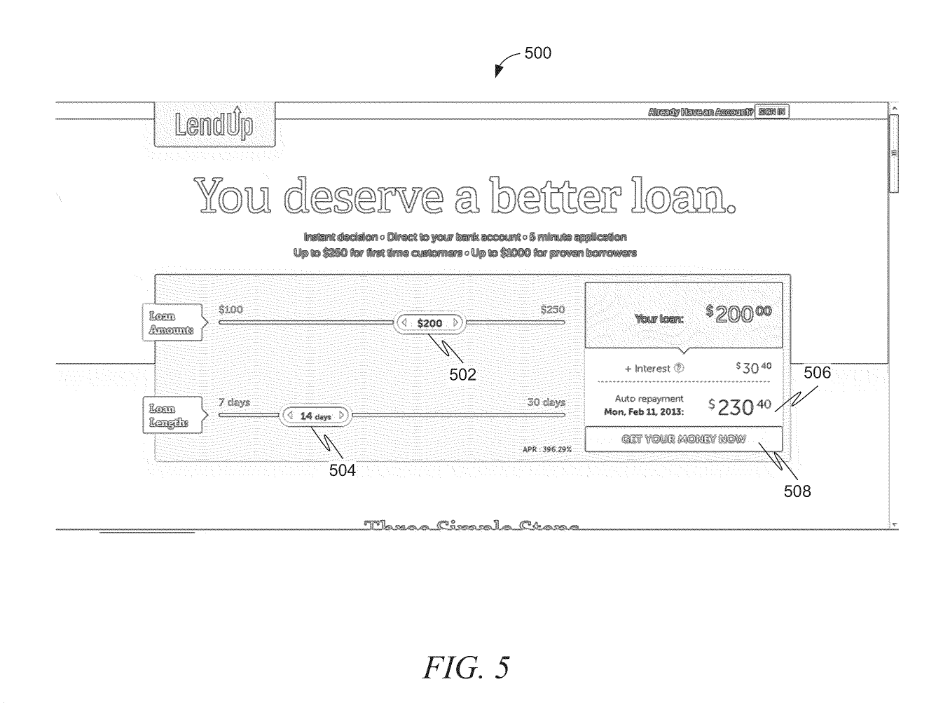

FIG. 5 is an illustrative drawing of a computer UI display component for use in selecting a loan amount and loan term and for generating a corresponding repayment amount, in accordance with some embodiments. In some embodiments, the computer user interface display component of FIG. 5 is displayed in the user interface described in operation 302 of FIG. 3. The display component 500 includes a first user interface slider bar 502, displayed on a UI of the device 104, that corresponds to a loan amount. A second UI slider bar 504 is displayed on a UI of the device 104 that corresponds to a repayment time period, otherwise known as the loan length. A user dynamically slides the first UI slider bar 502 and dynamically slides the second UI slider bar 504 to different positions in order to dynamically generate corresponding loan repayment amounts, which are displayed at 506. When a combination of loan amount, time period, and repayment are determined, a user may indicate that he or she wishes to apply for a loan with those parameters (by, for example, pressing button 508). The process described with reference to FIGS. 1-4 determines the user's eligibility for a loan on those terms.

It should be noted that while FIG. 5 depicts only two UI slider bars 502, 504, additional UI slider bars could be provided for other parameters of the loan, such as origination points. The present disclosure isn't limited to interfaces having only two UI slider bars.

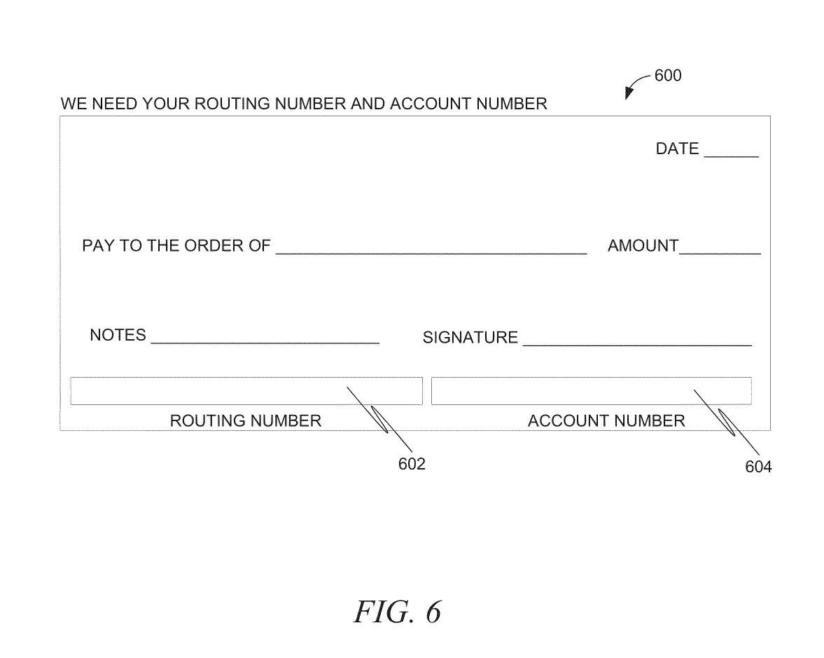

FIG. 6 is an illustrative drawing of a computer UI display for use in obtaining user information to use a user's bank account in connection with an ACH or wire transfer, in accordance with some embodiments. An image 600 with the look and feel of a physical check is displayed, which includes a field 602 for entry of a routing number and a field 604 for entry of an account number. The check image shows the relative locations of these fields so as to make it easier for a user to locate the required information on a real physical check and to enter it into the appropriate fields of the user interface. This makes it easier for the user to determine where on a physical check to locate the information requested by the computer UI display of FIG. 6.

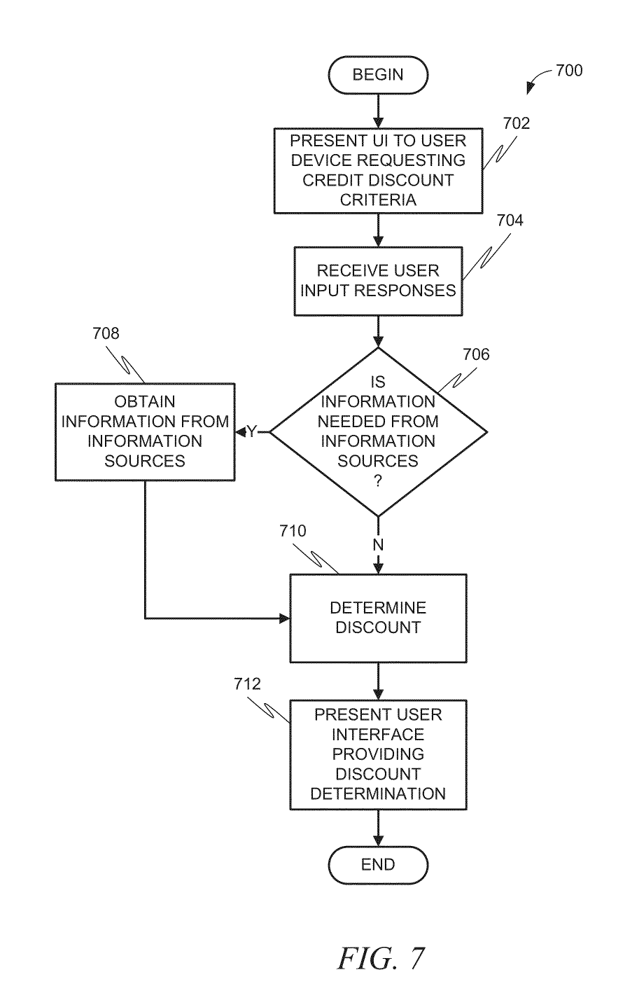

FIG. 7 is an illustrative flow diagram 700 of a process to determine personalized real time credit, in accordance with some embodiments. The dynamic decision system 102 is configured using computer program code to implement the acts specified with reference to the operations of the flow diagram 700. Pursuant to the process 300 illustrated in FIG. 3, before, during, or after the credit approval, a user may be offered a discount to arrive at personalized pricing based upon the user's creditworthiness. This may be most useful in the case where the user has previously applied for and been granted loans from this same entity. The entity may wish to provide a discount for future loans, either as a reward for on-time payment performance of an existing loan (e.g., “you have made 12 on-time payments on your current loan, you are now eligible for a reduced loan fee for a future loan), or to encourage the consumer to pay off the previous loan (e.g., “once you pay off your current loan, we can offer you a reduced loan fee on your next loan”). Interest rate and fees associated with a loan may be adjusted in real time, based upon factors such as a personalized customer risk score or willingness or incentives to share additional information. Operation 702 presents a UI display to the user device 104 that requests information from the user about certain credit discount criteria. At operation 704, user input responses to the credit discount criteria requests are received. At operation 706, it is determined whether information is needed from information sources. If so, then at operation 708, the system may send appropriate requests to one or more information sources and receive responses. Once this is done, or if no additional information was deemed to be needed at operation 706, then at operation 710 a discount, as a function of the user response and information gathered from the information sources, may be determined. This discount may also be a function of user behavior engaged in while providing the user responses at operation 704. At operation 712, a UI providing the discount determination may be presented to the user.

The additional information may include information from data sources online that come from publicly available information (such as social networking, blogs, public posts), public data sources (e.g., such as public records, census), private data sources (e.g., such as credit bureau), or uploading personal files using a website upload, scan and upload, webcam, mobile phone cam, or pull from a third party website (e.g., such as paystub, phone bill, bank statement, etc.). In some embodiments, criteria for a discount also may arise due to indicia such as the user taking courses on credit education, good financial behavior, sharing news/opinions on social media or in viral channels, proactive payments, sharing additional personal information, finding community sponsors, and/or participating in certain blogs and posts. Operation 710 determines one or more discounts applicable to the user based upon the user responses and any additional information received through operation 708. The process may repeat if the user provides additional discount information.

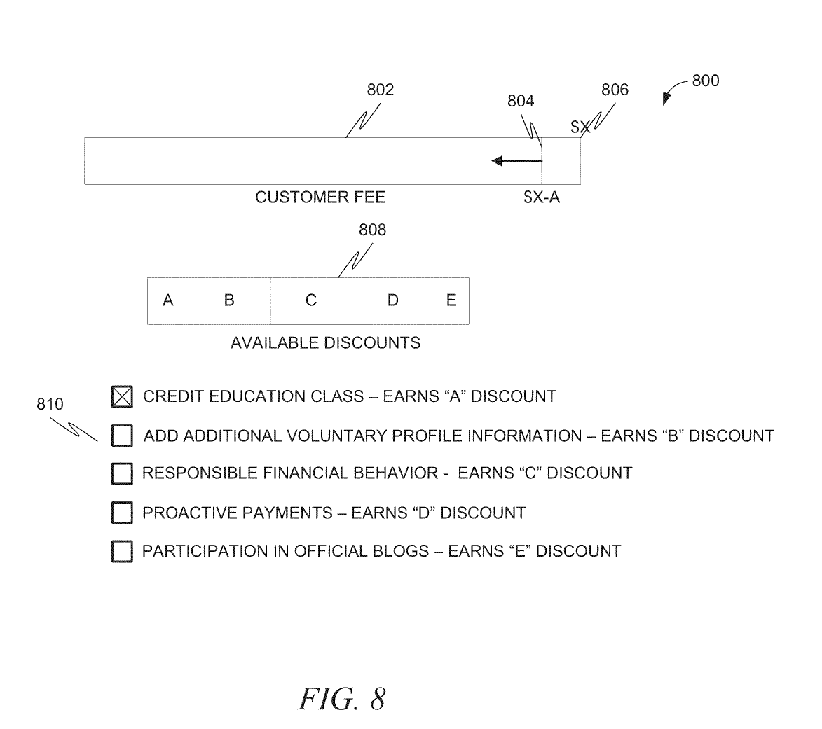

FIG. 8 is an illustrative drawing of a UI display that can be presented by the system 102 to a user device 104 to request user discount information for use in determining real time pricing of credit, in accordance with some embodiments. In the UI display 800, a ‘customer fee’ field 802 shows the actual customer fee for credit with discounts applied. (Customer Fee=Retail Fee ($X) minus Discounts. Here, a bar 804 depicts where the current fee is with respect to the original retail fee 806. In this case, the user has been provided with and selected a particular discount, discount A, that results in a reduction of the original retail fee of $X to $X−A. A ‘discounts’ 808 field shows relative amounts of discounts that are available for different trust discounts in bar chart form. For example, here a user is provided with five potential discounts, each with its own relative discount amount. It should be noted that these discounts may be personalized for the particular user. A first user might be a good credit risk, and the system 102 determines to provide a $1 discount for paying on time to reinforce such good behavior. A second user might be a riskier credit risk, and therefore, might get a higher incentive for paying on time. Or, the incentive might be provided the other way around.

In response to a determination that one or more discount options are available for a particular user/applicant, the dynamic decision system 102 causes a UI display of the amount of each possible discount. The system 102 may determine that different discounts are available for different time frames (e.g., future discounts versus a current loan discount). The system 102 also may cause the UI to indicate different discounts for different time frames.

A list of the trust discount items is provided at 810 with ‘check box’ fields in which a user can indicate whether the discount item is selected. Here, the user has selected to participate in a credit education class, which corresponds to the “A” discount, which is then reflected in the customer fee field 802. If the user selects another discount from 810 by checking another check box, the bar 804 would move even further to the left, indicating an even lower customer fee.

Alternatively, for example, an icon or selectable word may be provided instead of a check box. The user check box inputs are received by the dynamic decision system 102. Note that certain extracurricular activity may be required, such as uploading documents or attending classes, in order to qualify for the discount item. Such activity may be subject to verification from an information source 106.

It should also be noted that in some cases the user need not select one of the discounts. The lending entity can choose to automatically apply one or more of the discounts to the user, and indicate as such by automatically checking one of the check boxes at 810. For example, if the user has indeed participated in responsible financial behavior, check box 812 may be automatically checked.

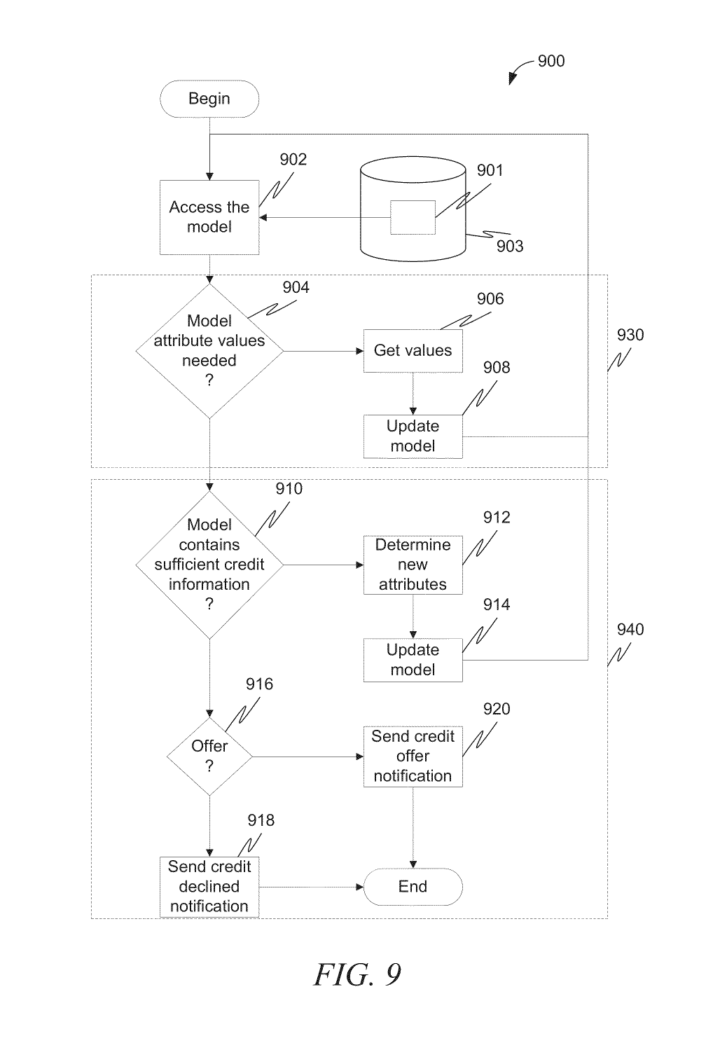

FIG. 9 is an illustrative drawing representing a recursive process 900 to configure a computer system to obtain information to update a user model 901 encoded in a computer readable storage device 903 and to use the model to determine an offer of credit to a user in accordance with some embodiments. Modules in the illustrative flow diagram correspond to computer program code that configures a computer system to implement the acts specified with reference to the modules. Module 902 accesses a model 901 to determine content of the model and to update content of the model, for example. Accessing (indicated by dashed lines) a model 901, for example, may include reading contents of the model from the storage device 903 and also may include modifying contents of the model 901 stored in the storage device. As explained more fully below a model may include attribute identifiers referred to herein as ‘keys’ that indicate attributes that are relevant to a credit determination. A model 901 also may include corresponding attribute values that correspond to the attribute identifiers. The process 900 assembles a model that is indicative of an individual's creditworthiness as a function of information that the process 900 obtains directly from the individual directly and that the process obtains indirectly from other sources. The process 900 evaluates an individual's creditworthiness as a function of the assembled model, which is customized to a particular user seeking credit. Significantly, the process 900 iteratively uses information obtained from or obtained about an individual as a basis for determining what additional information to obtain from or about the individual that is to be included in the model 901. The process 900 configures a computer system to obtain the information required for such customized model from any one or more of a variety of sources over a network (not shown).

Decision module 904 determines whether the accessed model 901 includes keys, i.e. identified attributes, and whether the model lacks attribute values for one or more identified attributes. In other words, decision module 904 determines whether the accessed model 901 identifies one or more attributes for which no actual attribute value is provided in the model 901. For example, the model may not include any attribute values for a credit score. In response to a determination that the model 901 includes one or more attribute keys that lack corresponding attribute values, module 906 obtains the missing attribute values. It will be appreciated that in some embodiments, module 904 and 906 may be subsumed into a single module. As explained more fully below, obtaining a missing attribute value may involve sending a UI display over a network to a user device wherein the UI display makes a request to the user for the missing attribute information. Alternatively, or in addition, obtaining a missing attribute value may involve sending a request over the network to a collateral source such as a credit reporting agency. As yet another alternative, obtaining a missing attribute value may involve sending a request for the information to a storage device where the information is stored.

Module 908 modifies the model 901 by adding the one or more obtained attribute values. More specifically, in some embodiments, module 908 access the model via module 902 to modify contents of the model 901 by associating the one or more values obtained using module 906 with corresponding attribute keys within the model 901, and stores the modified model 901 into the memory device 903. Even more particularly, in some embodiments, accessing the model 901 by module 908 may include modifying contents of the model 901 by associating obtained attribute values with attribute identifiers. Moreover, the attribute values may be associated with attributes added to the model 901 using module 914 described below.

Following module 908 the process 900 recurses (i.e. recycles) in part and control again flows to decision module 904. In response to a determination by decision module 904 that the model 901 does not include an attribute key that lacks a corresponding attribute value, control flows to decision module 910 in which a determination is made as to whether adequate information is contained in the model to make a creditworthiness decision for a user credit applicant. As described above with respect to FIG. 3, this determination may include an analysis of user behavior, as well as other analyses. In response to a determination that the model 901 does not contain sufficient information to make a creditworthiness assessment for a user applying for credit, module 912 determines additional credit related attributes to investigate for the user. It will be appreciated that in some embodiments, module 910 and 912 may be subsumed into a single module. As explained more fully below, a determination by module 910 that the model 901 does not contain sufficient creditworthiness information may depend upon an evaluation of the attribute values obtained using module 908.

Module 914 modifies the model 901 by adding one or more attribute keys. More specifically, in some embodiments, module 914 access the model via module 902 to modify contents of the model 901 by adding one or more additional attribute keys that are identified using module 912. Following module 914 the process 900 recurses in part and control flows to decision module 904, which makes a determination as to whether the attribute keys newly added using module 914 require attribute values.

In response to a determination by module 910 that the model 901 does contain sufficient information to make a creditworthiness assessment for a user applying for credit, decision module 916 determines whether or not to extend an offer of credit. In response to a determination by decision module 916 that credit will not be extended, module 918 sends to a user over a network a notification that the user's credit request is declined. In response to a determination using decision module 916 that credit is to be extended, module 920 sends to a user over the network a notification that the user's credit request is accepted. In some embodiments, the credit acceptance notification includes an indication of the amount and terms of the offer of credit, which may be different in whole or in part from the user's original request. The offer may be, for example, customized based on the user's creditworthiness or other factors, possibly influenced by user behavior. In some embodiments the terms of the offer of credit are determined as a function of the model 910 as modified using modules 908 and 914. 901A₆

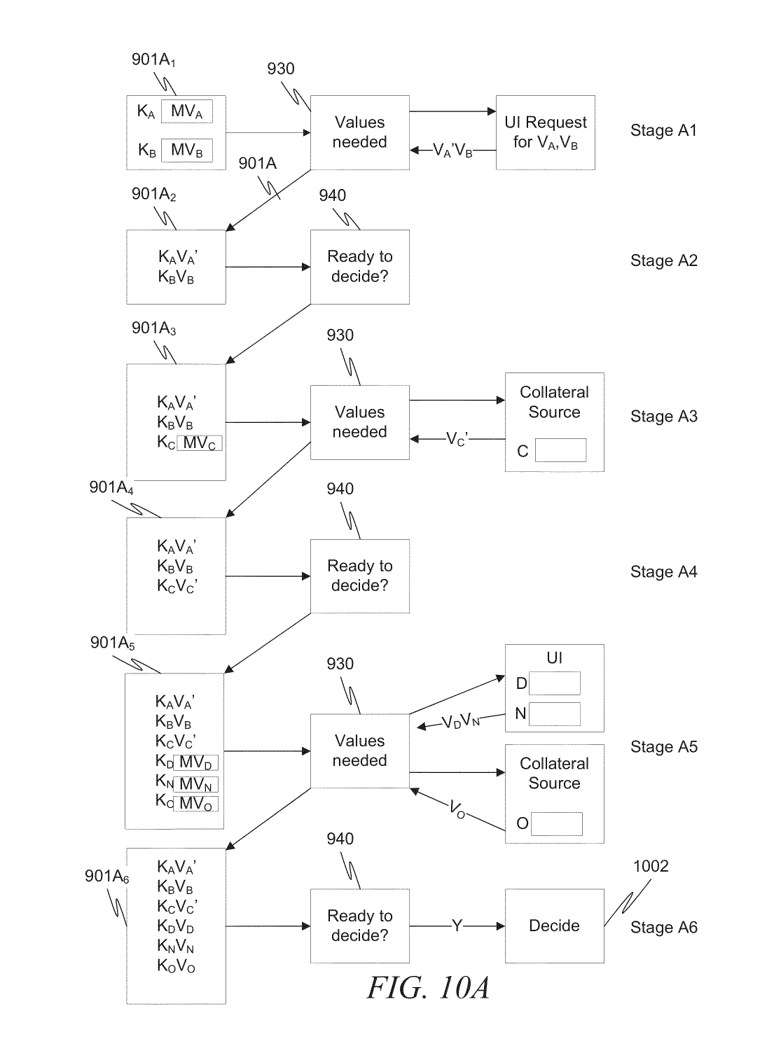

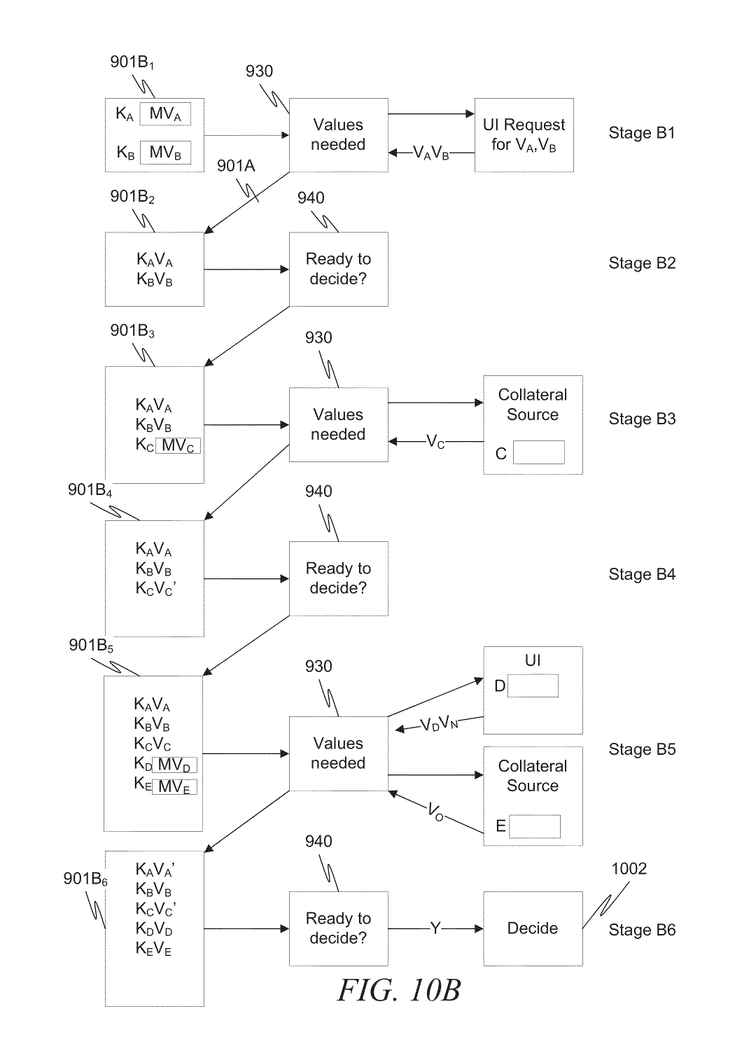

FIGS. 10A-10B are illustrative drawings of modification of models 901A and 901B through multiple stages; the sending over a network of multiple UI display containing requests for attribute information; the sending of requests to collateral sources for attribute information; the corresponding receiving of responsive attribute information over the network; and the determination of a creditworthiness as a function of the attributes and associated attribute information of the models as modified pursuant to the process of FIG. 9.

It will be understood from FIGS. 10A-10B that starting from an identical ‘seed’ model, the process 1000 can develop different models for different users as a function, at least in part, of attribute values and attributes within the model. Furthermore, it will be appreciated that the process 1000 determines where to obtain additional attributes, at least in part, as a function of attributes and attribute values previously contained within the model. Moreover, it will be appreciated that the process determines what additional attributes to add to a model, at least in part, as a function of attributes and attribute values previously contained within the model.

Referring to FIG. 10A, the process 1000 modifies the model 901A successively through stages 901A1 to 901A6. In FIG. 10A, the modules labeled 930 each represent an instance (i.e. an occurrence) of the portion of the process 900 enclosed within dashed lines 930 in FIG. 9. The portion of the process 930 acts to determine whether one or more keys in the credit model lack a corresponding attribute value. In FIG. 10A, the modules labeled 940 each represent an instance (i.e. an occurrence) of portion of the process 900 enclosed within dashed lines 940 in FIG. 9. The portion of the process 940 acts to determine whether the credit model includes adequate attributes to make a determination of creditworthiness of a requester of credit.

Referring to stage A1, an initial model 901A1, which may be a ‘seed’ model, is provided to the module 930. The seed model 901A1 contains attribute ‘keys’ K_{A} and K_{B}, but is missing attribute values for these as indicated by associated structures labeled MV_{A} and MV_{B} (missing values A1 and A2). Module 930 recognizes that K_{A} and K_{B} have missing attribute values. The module 930 determines where to obtain the missing values, and in this example, sends a UI display over a network to a user device that contains a request for values V_{A} and V_{B} corresponding to attributes K_{A} and K_{B}. The user device sends to module 930 a response that contains the requested values V_{A}′ and V_{B}. The module 930 modifies the model 901A1 by adding the provided values to the model to transition it to model 901A2 shown in stage A2.

Referring to stage A2, module 940 determines whether the model version 901A2 is ready for a creditworthiness decision. In this example, the module 940 determines that a creditworthiness decision is premature, and modifies the model 901A2 by adding another attribute key K_{C} to the model to transition it to model 901A3 shown in stage A3.

Referring to stage A3, module 930 recognizes that K_{C} has a missing attribute value, MV_{C}. The module 930 determines where to obtain the missing values, and in this example, sends a request over a network to a collateral source for value V_{C} corresponding to attribute K. The collateral source sends to module 930 a response that contains the requested value V_{C}′. The module 930 modifies the model 901A3 by adding the provided value V_{C}′ to the model to transition it to model 901A4 shown in stage A4.

Referring to stage A4, module 940 determines whether the model version 901A4 is ready for a creditworthiness decision. In this example, the module 940 determines that a creditworthiness decision is premature, and modifies the model 901A4 by adding attributes K_{D}, K_{N} and K_{O} to the model to transition it to model 901A5 shown in stage A5.

Referring to stage A5, module 930 recognizes that attributes K_{D}, K_{N} and K_{O} have missing attribute values, MV_{D}, MV_{N} and MV_{O}. The module 930 determines where to obtain the missing values, and in this example, sends a UI display over a network to a user device that contains a request for values V_{D} and V_{N} corresponding to attributes K_{D} and K_{N}. The user device sends to module 930 a response that contains the requested values V_{D} and V_{N}. The module 930 also sends a request over a network to a collateral source for value V_{O} corresponding to attribute K_{O}. The collateral source sends to module 930 a response that contains the requested value V_{O}. The module 930 modifies the model 901A5 by adding the provided values V_{D}, V_{N} and V_{O} to the model to transition it to model 901A6 shown in stage A6.

Referring to stage A6, module 940 determines whether the model version 901A6 is ready for a creditworthiness decision. In this example, the module 940 determines that the model version 901A6 is ready for a creditworthiness decision, and provides a decision 1002 that corresponds to either module 918 or 920 of FIG. 9 depending upon the decision. In particular, the module 940 determines a credit offer in response to determinations that no key lacks a corresponding attribute and that that the credit model includes adequate attributes to make a determination of creditworthiness of the requester of credit.

Referring now to FIG. 10B, the process 1000 modifies the model 901B successively through stages 901B1 to 901B6. In FIG. 10B, the modules labeled 930 each represent an instance (i.e. an occurrence) of the portion of the process 900 enclosed within dashed lines 930 in FIG. 9. In FIG. 10B, the modules labeled 940 each represent an instance (i.e. an occurrence) of portion of the process 900 enclosed within dashed lines 940 in FIG. 9.

Referring to stage B1, an initial model 901A1, which may be a ‘seed’ model, is provided to the module 930. The seed model 901A1 contains attribute ‘keys’ K_{A} and K_{B}, but is missing attribute values for these as indicated by associated structures labeled MV_{A} and MV_{B} (missing values A1 and A2). Module 930 recognizes that K_{A} and K_{B} have missing attribute values. The module 930 determines where to obtain the missing values, and in this example, sends a UI display over a network to a user device that contains a request for values V_{A} and V_{B} corresponding to attributes K_{A} and K_{B}. The user device sends to module 930 a response that contains the requested values V_{A} and V_{B}. The module 930 modifies the model 901B1 by adding the provided values V_{A} and V_{B} to the model to transition it to model 901B2 shown in stage B2.

Note that the value V_{A}′ returned in stage A1 of FIG. 10A is different from the value V_{A} returned in stage B1 of FIG. 10B, and therefore, the model version 901A2 shown in stage A2 is different from the model version 901B2 shown in stage B2.

Referring to stage B2, module 940 determines whether the model version 901B2 is ready for a creditworthiness decision. In this example, the module 940 determines that a creditworthiness decision is premature, and modifies the model 901B2 by adding another attribute key K_{C} to the model to transition it to model 901B3 shown in stage B3.

Referring to stage A3, module 930 recognizes that K_{C} has a missing attribute value, MV_{C}. The module 930 determines where to obtain the missing values, and in this example, sends a request over a network to a collateral source for value V_{C} corresponding to attribute K_{C}. The collateral source sends to module 930 a response that contains the requested value V_{C}′. The module 930 modifies the model 901A3 by adding the provided value V_{C}′ to the model to transition it to model 901A4 shown in stage A4.

Referring to stage B4, module 940 determines whether the model version 901B4 is ready for a creditworthiness decision. In this example, the module 940 determines that a creditworthiness decision is premature, and modifies the model 901B4 by adding attributes K_{D} and K_{E} to the model to transition it to model 901B5 shown in stage B5.

Note that the attributes K_{D}, K_{N} and K_{N} added in stage A5 of FIG. 10A are different from the attributes K_{D} and K_{E} added in stage B5, which is a further reason the model version 9015 shown in stage A5 is different from the model version 901B5 shown in stage B5.

Referring to stage B5, module 930 recognizes that attributes K_{D}, and K_{E} have missing attribute values, MV_{D} and MV_{E}. The module 930 determines where to obtain the missing values, and in this example, sends a UI display over a network to a user device that contains a request for values V_{D} corresponding to attribute K_{D}. The user device sends to module 930 a response that contains the requested value V_{D}. The module 930 also sends a request over a network to a collateral source for value V_{E} corresponding to attribute K_{E}. The collateral source sends to module 930 a response that contains the requested value V_{E}. The module 930 modifies the model 901B5 by adding the provided values V_{D} and V_{E} to the model to transition it to model 901B6 shown in stage A6.

Referring to stage B6, module 940 determines whether the model version 901B6 is ready for a creditworthiness decision. In this example, the module 940 determines that the model version 901B6 is ready for a creditworthiness decision, and provides a decision 1002 that corresponds to either module 918 or 920 of FIG. 9 depending upon the decision.

It will be understood that the creditworthiness decision reached in the example of FIG. 10A may be quite different from the creditworthiness determination in FIG. 10B since the model version 901A6 is quite different from the model version 901B6.

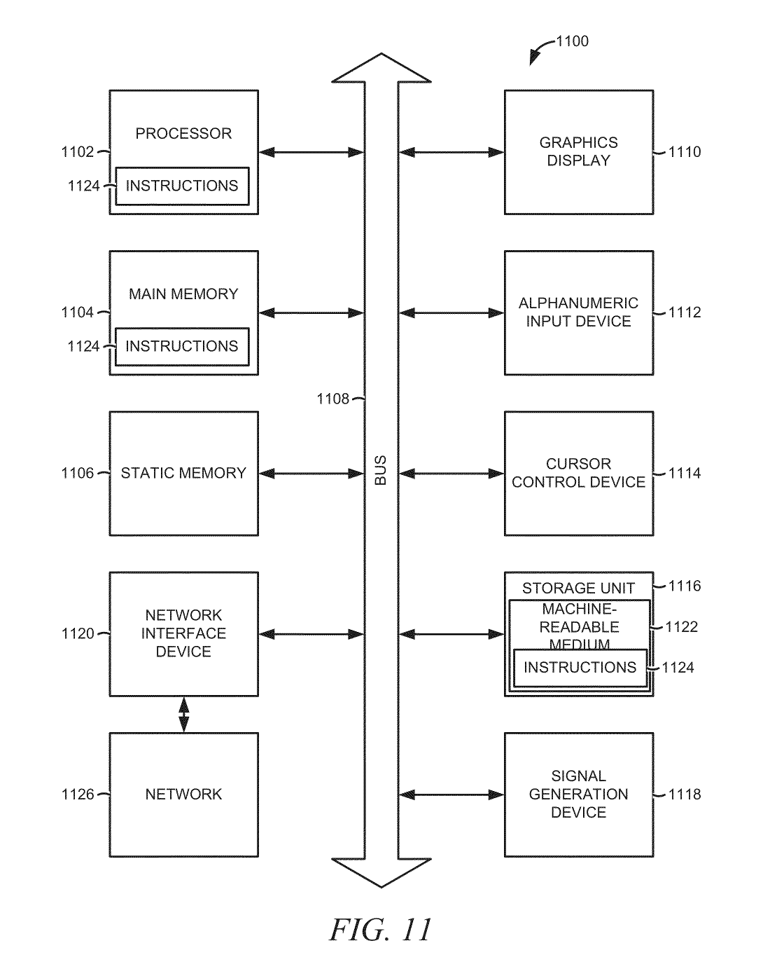

FIG. 11 is a block diagram of a computer processing system at a server system, within which a set of instructions, for causing the computer to perform any one or more of the methodologies discussed herein, may be executed.

Embodiments may also, for example, be deployed by Software-as-a-Service (SaaS), application service provider (ASP), or utility computing providers, in addition to being sold or licensed via traditional channels. The computer may be a server computer, a PC, a tablet PC, a STB, a PDA, cellular telephone, or any processing device capable of executing a set of instructions (sequential or otherwise) that specify actions to be taken by that device. Further, while only a single computer is illustrated, the term “computer” shall also be taken to include any collection of computers that individually or jointly execute a set (or multiple sets) of instructions to perform any one or more of the methodologies discussed herein.

The example computer processing system 1100 includes processor 1102 (e.g., a central processing unit (CPU), a graphics processing unit (GPU) or both), main memory 1104 and static memory 1106, which communicate with each other via bus 1108. The processing system 1100 may further include graphics display unit 1110 (e.g., a plasma display, a liquid crystal display (LCD), or a cathode ray tube (CRT)). The processing system 1100 also includes alphanumeric input device 1112 (e.g., a keyboard), a cursor control device 1114 (e.g., a mouse, touch screen, or the like), a storage unit 1116, a signal generation device 1118 (e.g., a speaker), and a network interface device 1120.

The storage unit 1116 includes a machine-readable medium 1122 on which is stored one or more sets of instructions 1124 and data structures (e.g., software) embodying or utilized by any one or more of the methodologies or functions described herein. The instructions 1124 may also reside, completely or at least partially, within the main memory 1104 and/or within the processor 1102 during execution thereof by the processing system 1100, with the main memory 1104 and the processor 1102 also constituting machine-readable, tangible media.

The instructions 1124 may further be transmitted or received over network 1126 via a network interface device 1120 utilizing any one of a number of well-known transfer protocols (e.g., HTTP).

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the computer and that cause the computer to perform any one or more of the methodologies of the present application, or that is capable of storing, encoding, or carrying data structures utilized by or associated with such a set of instructions. The term “machine-readable medium” shall accordingly be taken to include, but not be limited to, solid-state memories and optical and magnetic media.

While various implementations and exploitations are described, it will be understood that these embodiments are illustrative and that the scope of the claims is not limited to them. In general, techniques for maintaining consistency between data structures may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims.

While the embodiments are described with reference to various implementations and exploitations, it will be understood that these embodiments are illustrative, and that the scope of claims provided below is not limited to the embodiments described herein. In general, the techniques described herein may be implemented with facilities consistent with any hardware system or hardware systems defined herein. Many variations, modifications, additions, and improvements are possible.

The term “machine readable medium” is used generally to refer to media such as main memory, secondary memory, removable storage, hard disks, flash memory, disk drive memory, CD-ROM, and other forms of persistent memory. It should be noted that program storage devices, as may be used to describe storage devices containing executable computer code for operating various methods, shall not be construed to cover transitory subject matter, such as carrier waves or signals. Program storage devices and machine readable mediums are terms used generally to refer to media such as main memory, secondary memory, removable storage disks, hard disk drives, and other tangible storage devices or components.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

1. A method of providing a credit line or loan to a consumer, the method comprising:
providing, via one or more network interface devices of a computer system, information defining a first user interface renderable on a computing device of the consumer;
receiving, via the one or more network interface devices, data representative of consumer interaction behavior with the first user interface;
monitoring, through execution of instructions of at least one processor of the computer, system the received data representative of interaction behavior of the consumer while the consumer interacts with the first user interface;
receiving, via the one or more network interface devices, first user responses in response to the consumer interaction with the first user interface;
determining a first set of information sources from which to retrieve information based on the first user responses;
receiving, via the one or more network interface devices, first credit information from the first set of information sources;
providing a credit model that includes one or more keys in the one or more computer-readable storage devices;
modifying the credit model by associating, in the one or more computer-readable storage devices, one or more attribute values, that correspond to the received first credit information, with one or more corresponding keys of the credit model;
receiving a determination of whether the credit model in which all keys are associated with attribute values is currently storing sufficient credit information to make a decision regarding the credit line or loan;
in response to receipt of a determination that the credit model is not currently storing sufficient credit information to make a decision regarding the credit line or loan, further modifying the credit model by iteratively repeating the acts of,
adding one or more additional keys to the credit model,
acquiring, via the one or more network interfaces from at least one source that is different from the sources from which credit information was acquired previously, additional credit information that corresponds to the one or more additional keys,
associating one or more additional attribute values, that correspond to the additional credit information, with the one or more additional keys of the credit model,
receiving a determination of whether the credit model in which all keys are associated with attribute values is currently storing sufficient credit information to make a decision regarding the credit line or loan,
until receipt of a determination that the credit model on the one or more computer-readable storage devices is currently storing sufficient credit information to make a decision regarding the credit line or loan;
receiving a decision as to the credit line or loan based on the one or more attribute values and the iteratively acquired one or more additional attribute values stored in the credit model; and
transmitting, to the user computing device via the one or more network interfaces, information indicating the decision as to the credit line or loan.

2. The method of claim 1, wherein iteratively acquiring, via the one or more network interface devices, the one or more additional attribute values corresponding to the one or more additional keys of the credit model comprises:
receiving second consumer responses via the one or more network interfaces;
and
retrieving the first attribute value from second set of information sources.

3. The method of claim 1, further comprising, in response to a determination that the credit model has sufficient credit information to make a decision regarding the credit line or loan, determining how much credit to extend to the consumer based on the credit model.

4. The method of claim 1, wherein the determining the first set of information sources is based on monitored first consumer behavior while the consumer interacts with the first user interface displayed on the user computing device.

5. The method of claim 2, wherein the second set of information sources include one or more social networks and the second consumer responses include log-in information corresponding to the one or more social networks.

6. The method of claim 1, further comprising:
determining, based on the credit model, whether to provide any discounts to the consumer on the credit line or loan.

7. The method of claim 1, wherein the first user interface is a web page.

8. The method of claim 4, wherein the first user interface is a web page, and wherein the first consumer behavior is user interaction with the web page via a web browser.

9. (canceled)

10. The method of claim 1, wherein the first credit retrieved information includes channel information.

11. The method of claim 10, wherein the channel information includes information about the user computing device displaying the first user interface.

12. The method of claim 11, wherein the channel information includes a location of the user computing device.

13. The method of claim 11, wherein the channel information includes a brand of the user computing device.

14. The method of claim 11, wherein the channel information includes an operating system of the user computing device.

15. The method of claim 11, wherein the channel information includes a cellular carrier of the user computing device.

16-25. (canceled)
